(19) United States
(12) Patent Application Publication
(10) Pub. No.: US 2011/0049817 A1
(43) Pub. Date: Mar. 3, 2011

(54) Tool holder

(75) Inventor: Udo Hauptmann, Landsberg (DE)

(73) Assignee: Hilti Aktiengesellschaft, Feldkircherstrasse (LI)

(21) Appl. No.: 12/806,604

(22) Filed: Aug. 17, 2010

(30) Foreign Application Priority Data
Aug. 26, 2009 (DE) DE102009028 890.2

(51) Int. Cl. B23B 31/10

(52) U.S. Cl. 279/43.9

(57) ABSTRACT

The tool holder for a hammer drill has an external cover and an axially movable actuation sleeve for unlocking an inserted tool. The end area of the actuation sleeve on the tool side overlaps an end area of the cover on the machine side. A plastic coating made of an elastic material is spray-coated onto the end area of the actuation sleeve on the tool side and/or onto the end area of the cover on the machine side.

This claims the benefit of German Patent Application DE 10 2009 028 890.2, filed Aug. 26, 2009 and hereby incorporated by reference herein.

### FIELD OF THE INVENTION

The present invention relates to a tool holder for a power tool of the type known from British patent application GB 232 61 23 A1. A tool that is in the tool holder is unlocked by moving an actuation sleeve against a coil spring. No dust or drillings can penetrate into the areas where the actuation sleeve is connected to the housing parts of the power tool and of the tool holder.

### SUMMARY OF THE INVENTION

An object of the present invention includes sealing the actuation sleeve. The present invention provides a tool holder for a hammer drill having an external cover and an axially movable actuation sleeve for unlocking an inserted tool. The end area of the actuation sleeve on the tool side overlaps an end area of the cover on the machine side. A plastic coating made of an elastic material is spray-coated onto the end area of the actuation sleeve on the tool side and/or onto the end area of the cover on the machine side. The plastic coating is arranged at least partially between the actuation sleeve and the cover. This makes it possible seal the actuation sleeve and a hollow space that is surrounded by the sleeve and located at one end on the tool side.

One embodiment has a one-piece sealing ring whose radially outer section is made of an elastic plastic, and whose radially inner section is made of a brittle plastic, whereby the radially outer section touches an inner surface of the actuation sleeve. The one-piece sealing ring made of two different plastics has proven to be very effective for sealing purposes and to be durable. The one-piece structure of the sealing ring, that is to say, the integral joining of the material of the inner and outer sections, reduces the number of boundary surfaces in comparison to cases where conventional sealing rings are used near the actuation sleeve. The hard inner section mechanically supports the outer section. A cuff that protrudes perpendicularly with respect to an axis of a tubular base can be attached to said base and the radially inner section of the sealing ring can lie flat against a protruding area of the cuff.

One embodiment has a coil spring that is arranged coaxially inside the actuation sleeve, whereby the end of this spring on the machine side is supported on the radially inner section of the sealing ring. The tool holder can have locking elements for a tool upon which a force is exerted by the coil spring. The coil spring that is used for the locking mechanism holds the sealing ring in place. This advantageously allows the number of components of the tool holder to be kept to a minimum.

One embodiment provides that an end of the coil spring on the tool side axially exerts force on the actuation sleeve in the direction of an end of the tool holder on the tool side. The actuation sleeve can have a contact surface facing radially inwards against which the end of the coil spring on the tool side rests.

### BRIEF DESCRIPTION OF THE DRAWINGS

The description that follows explains the invention on the basis of examples of embodiments and figures. The figures show the following:

FIG. 1: a hammer drill;

FIG. 2: a tool holder of the hammer drill.

### DETAILED DESCRIPTION

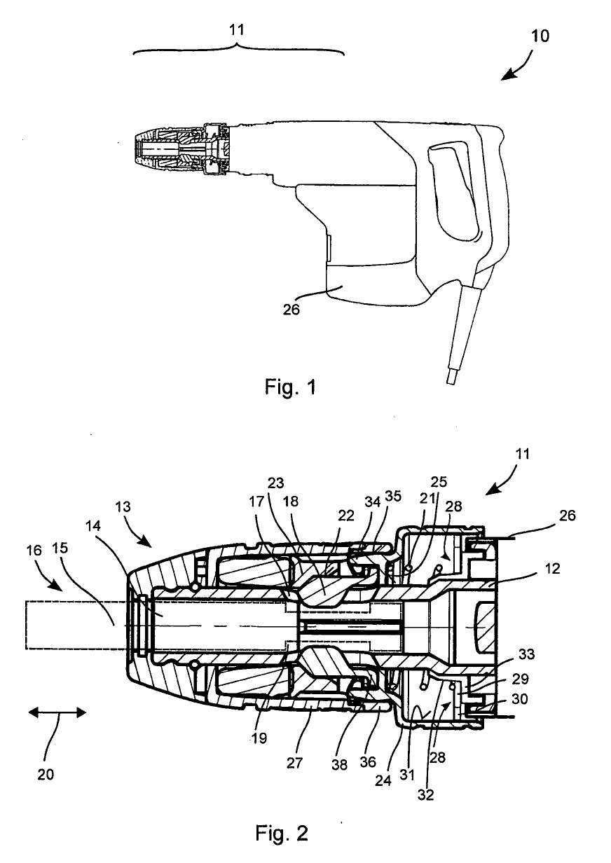

FIG. 1 shows a hammer drill 10 and a detailed view of an embodiment of a tool holder 11. A tubular base 12, as shown in FIG. 2, of the tool holder 11 for holding a tool is provided with a receiving opening 14 at one end 13 on the tool side. The shaft 15 of a tool 16, for instance, a drill, can be inserted through this receiving opening 14 lengthwise into the base 12.

The base 12 has lateral openings 17 through which the locking elements 18 engage from the outside into axially closed lengthwise grooves 19 in the shaft 15 of the tool 16. The locking elements 18 shown by way of an example are configured as pawls that can be moved in the axial direction 20.

In its basic position, the tool 16 is locked in the tool holder 11. A force is exerted onto the pawls 18 by a coil spring 21 in the direction of the receiving opening 14. In the position of the pawl 18 when it is advanced towards the receiving opening 14, the surface 22 of the pawl facing outwards in the radial direction is in contact with a link 23.

The tool 16 can be removed from the tool holder 11 in that a user pushes an axially movable actuation sleeve 24 away from the receiving opening 14. The actuation sleeve 24 has a contact surface 25 that is arranged between the pawls 18 and the coil spring 21 in the axial direction and upon which a force is exerted by the coil spring 21. Moving the actuation sleeve 24 and compressing the coil spring 21 cause the pawls 18 to be released from the link 23. The pawls 18 can be swiveled radially outwards around a point of rotation 38, thereby releasing the tool 16.

The hammer drill 10 has a machine housing 26 for the drive components. The tool holder 11 is surrounded by a cover 27. The movable actuation sleeve 24 is partially arranged between the machine housing 26 and the cover 27, so that the user can grasp the actuation sleeve 24 from the outside. In the embodiment shown, the coil spring 21 is located inside the actuation sleeve 24 in the axial direction. A front section 34 of the actuation sleeve 24 facing in the direction of the receiving opening 14 is arranged radially inside the cover 27. An edge 36 of the cover on the machine side is made of a soft elastic plastic having, for instance, a Shore A hardness ranging from 50 to 95. The soft edge can be spray-coated onto the cover 27, the rest of which is made of hard plastic. The soft plastic coating 36 touches the front section 34 of the actuation sleeve 24 and ensures a dust-proof closure. As an alternative, a soft plastic coating that touches the cover 27 can be spray-coated onto the front section 34 of the actuation sleeve 24.

A dust seal on the end of the actuation sleeve 24 on the machine side comprises a sealing ring 28. The sealing ring 28 is pushed over the base 12 and is arranged between the machine housing 26 and the coil spring 21 in the axial direction. The coil spring 21 is in contact with a radial inner section 29 of the sealing ring 28. The sealing ring 28 is supported on a cuff 32 that is welded onto the base 12 or that is in positive contact with a conically expanding section of the base 12 and that is clamped by the coil spring 21.

A rim 33 of the cuff 32 is positioned perpendicularly to the axis of the base 12. On the machine side, the radial inner section 23 lies flat on the rim 33. When the coil spring 21 presses the sealing ring 28 against the cuff 32, this area is sealed so as to be dust-proof.

A radially outer section 30 of the sealing ring 28 is made of a soft, elastic plastic. The soft plastic of the outer section 30 is spray-coated onto the inner section 29. The outer section 30 touches the inside 31 of the actuation sleeve 24 and ensure a dust-proof seal.

What is claimed is:

1. A tool holder for a hammer drill, the tool holder having a tool side and a machine side, the tool holder comprising:
an external cover;
an axially movable actuation sleeve for unlocking an inserted tool, an end area of the actuation sleeve on the tool side overlapping an end area of the cover on the machine side; and
a plastic coating made of an elastic material spray-coated onto the end area of the actuation sleeve on the tool side and/or onto the end area of the cover on the machine side.

2. The tool holder as recited in claim 1 wherein the plastic coating is arranged radially between the actuation sleeve and the cover.

3. The tool holder as recited in claim 1 further comprising a one-piece sealing ring within a radially outer section made of an elastic plastic and a radially inner section made of a plastic more brittle than the elastic plastic, the radially outer section touching an inner surface of the actuation sleeve.

4. The tool holder as recited in claim 3 further comprising a coil spring arranged coaxially inside the actuation sleeve, an end of the coil spring on the machine side being supported on the radially inner section of the sealing ring.

5. The tool holder as recited in claim 4 wherein a further end of the coil spring on the tool side axially exerts force on the actuation sleeve in a direction of an end of the tool holder on the tool side.

6. The tool holder as recited in claim 5 wherein the actuation sleeve has a contact surface facing radially inwards against which the end of the coil spring on the tool side rests.

7. The tool holder as recited in claim 3 further comprising a tubular base having an axis and a cuff having a protruding area protruding perpendicularly with respect to the axis and attached to the base, the radially inner section of the sealing ring lying flat against the protruding area of the cuff.
